(19) United States
(12) Patent Application Publication
(10) Pub. No.: US 2009/0127134 A1
(43) Pub. Date: May 21, 2009

(54) Gas Sample Analysis

(76) Inventors: Keith Pratt, Drayton (GB); Andrew T. Yardley, Lee-on-the-Solent (GB); Terence N. Moran, Drayton (GB)

Correspondence Address: HONEYWELL INTERNATIONAL INC., 101 COLUMBIA ROAD, P O BOX 2245, MORRISTOWN, NJ, 07962-2245, US

(21) Appl. No.: 11/961,163

(22) Filed: Dec. 20, 2007

(30) Foreign Application Priority Data
Nov. 19, 2007 (GB) 0722674.9

(51) Int. Cl. G01F 1/64

(52) U.S. Cl. 205/779.5; 205/781

(57) ABSTRACT

A method of determining information about a gas sample includes:
causing bulk flow of the gas sample in an airstream along at least one flow channel such that all or a significant fraction of the gas sample is consumed on at least one adjacent sensing electrode whereby one or more electrolytic currents are generated, and
monitoring at least one electrolytic current so as to determine information about the gas sample.

### FIELD OF THE INVENTION

The invention relates to a method of determining information about a gas sample using an electrochemical gas sensor.

### BACKGROUND

Traditional electrochemical gas sensors include a capillary or membrane, the main function of which is to ensure that gas is fed to the sensing electrode in a diffusion limiting mode, thereby ensuring that the resulting gas response is relatively unaffected by the catalytic activity of the sensing electrode.

One disadvantage of this approach is that the sensitivity of the sensor is deliberately reduced, since only a small fraction of gas applied to the sensor is consumed (detected) by the sensing electrode. Also, the behaviour of the sensor is still affected by the properties of the capillary or membrane—which may vary from one sensor to another, and which are dependent on environmental factors such as temperature, albeit to a lesser extent than those of the electrode.

When such a sensor is used in a flowing air stream, a significant excess flow of gas must be supplied; otherwise the sensor response will be affected by the flow of gas, rather than being determined by the properties of the capillary/membrane.

GB-A-2380552 describes a conventional diffusion limited electrochemical gas sensor. The intention in this device is to provide excess gas flow to ensure that the gas concentration is not significantly depleted while traversing the flow cell, thereby obtaining maximum sensitivity.

U.S. Pat. No. 4,017,373 describes an electrochemical sensor in which the gas being analyzed flows through a shallow recess into contact with one side of the sensing electrode rather than being controlled by means of a gas phase diffusion barrier or the like. This device is concerned mainly with the problem of electrolyte drying out in use. This is overcome by the use of a cap containing a separate chamber of electrolyte with which the sample gas is saturated prior to being fed to the sensor to prevent evaporation of electrolyte from the sensor into the gas stream. As with other conventional electrical gas sensors, only a small portion of the gas being analyzed needs to be supplied to the sensing electrode and a separate channel is included in this case for gas to bypass the sensing electrode.

EP-A-0729027 refers in more general terms to a membrane enclosed sensor in which an elongate flow channel is provided in contact with a sensor membrane. The object is to ensure that the flow along a channel is sufficiently high to ensure that the sensor signal is independent of flow. The intention is to be within the region where current is (or is almost) independent of flow, i.e. the flow rate is high.

One problem with the sensors described above is that they require a high flow rate of gas while in addition the behaviour of the sensor is affected by properties of its components. This means that techniques must be adopted to compensate for these variations when determining concentration and the like.

GB-A-2194639 discloses a method for the determination of an active gas in a gas mixture based on a different principle. In this case, the gas mixture is passed into a chamber of known volume, and the chamber is sealed. The chamber contains a galvanic sensor providing a signal current, proportional to the rate of reaction of the active gas at the sensor electrode, to a current measuring device. After sealing the chamber, a signal processing means samples the signals from at least two different times, and calculates the sensitivity of the sensor and the concentration of the active gas. GB2194639 still needs some form of diffusion limitation in between the gas chamber and the sensing electrode, to prevent the sensor being overloaded (in which case some of the gas can pass through the working electrode unreacted and hence undetected and in extreme cases can reach the reference/counter electrode causing an interfering signal leading to inaccuracies).

### BRIEF DESCRIPTION OF THE DRAWINGS

FIG. 1 is a schematic diagram of an electrochemical sensor;

FIG. 2 illustrates four electrochemical sensors arranged in series;

FIGS. 3A-3C illustrate the passage of a gas pulse along the channel of the sensor shown in FIG. 1 while FIGS. 3D and 3E illustrate the variation of gas concentration and sensor current respectively with time;

FIG. 4A illustrates the flow channel and sensing electrode in more detail;

FIG. 4B illustrates graphically the concentration of a gas sample along the flow channel of FIG. 4A when all gas is consumed and when some gas escapes respectively;

FIGS. 5A and 5B illustrate two examples of flow channel configurations;

FIG. 6 illustrates an example in which multiple sensing electrodes are provided along the flow channel;

FIG. 7 illustrates a serpentine flow channel and associated sensing electrodes;

FIG. 8 illustrates the area of operation of methods according to the invention and contrasts these with other areas of operation; and,

FIG. 9 illustrates a channel of another embodiment of the invention.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

In accordance with the present invention, we provide a method of determining information about a gas sample using an electrochemical gas sensor assembly having one or a number of sequentially arranged sensing electrodes, one or more counter electrodes, and an electrolyte, the sensor assembly including one or more flow channels extending across the or all the sensing electrodes, the method includes:

causing bulk flow of the gas sample in an airstream along the flow channel(s) such that all or a significant fraction of the gas sample is consumed on the sensing electrode(s) whereby one or more electrolytic currents are generated, and

monitoring the electrolytic current(s) so as to determine information about the gas sample.

In embodiments of this invention, in contrast to the known flow systems, we arrange for all, or a significant fraction of, the gas sample to be consumed. This differs significantly from the prior art flow systems, where the intention is to ensure that only a small fraction of gas is consumed—in such systems gas consumption results in an erroneously low reading because the sensor is effectively ‘seeing’ an artificially low gas concentration. In the present invention the opposite is the case.

Further, we avoid the need to use a capillary or other membrane to limit the supply rate of target gas to the sensing electrode while ensuring that all or a significant fraction of the gas sample is consumed on the sensing electrode(s). The resulting signal then directly provides an absolute measure of the target gas without requiring calibration of the sensor. If the sensor consumes all the gas, the total charge passed provides a direct measure of the number of moles of gas.

The electrochemical gas sensor assembly may comprise a single sensor with sensing and counter electrodes and an optional reference electrode. In this case at least 90% of the gas is preferably consumed.

In other examples, a series of such sensors are used while in further examples more than one sensing electrode is provided in the same sensor. In these examples, the significant fraction is at least 10%, preferably at least 50%, most preferably at least 75%.

In the simplest form of the invention, all of the gas is assumed to react within the flow channel. However, by using multiple electrodes/sensors one can correct for situations where not all (but still a significant fraction of) the gas is consumed. Also by using multiple electrodes/sensors and running the sensor assembly in a regime where a significant fraction of the gas is consumed, additional information about the gas and/or sensor can be obtained.

In the case of a gas pulse, this enables gas concentration to be obtained very easily while for gas flowing continuously, information about the gas concentration can still be obtained providing the flow rate is known. This could be achieved using, for example, a thermal flow meter such as a mass flow meter, or could be controlled using a pump with constant or controlled flow rate.

Different gases can be distinguished by using the multiple electrode/multiple sensor approach if run in the regime where not all of the gas is consumed by the first sensor. This uses the principle that a gas which reacts rapidly will be consumed more completely by the first sensor and will give a small (or zero) fraction of the total signal on the second sensor, whereas a gas which reacts slowly will give a greater fraction of signal on the second (or even subsequent) sensors. Thus the ratio of signals on two or more series connected sensors can allow determination of gas type. This is in effect the same approach as using the system to determine activity of the sensing electrode since the same parameter is being measured—namely the rate of reaction of the gas with the electrode.

The flow channel, or, each flow channel is, are preferably designed such that it maximises the contact of gas with the sensing electrode, i.e. it avoids allowing gas to pass through the channel without reacting. Preferred designs are serpentine and spiral shaped. These tortuous channels also minimize diffusion along the channels.

Some examples of methods according to the invention will now be described with reference to the above noted drawings.

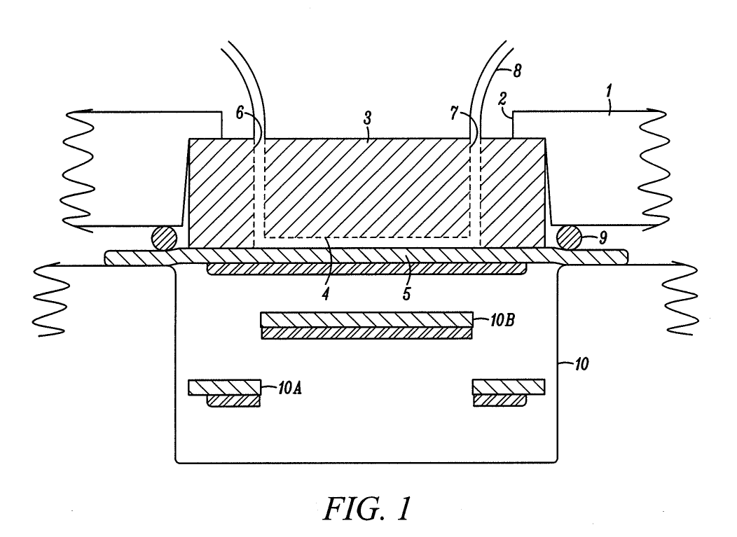

FIG. 1 illustrates a first example of an electrochemical gas sensor constructed for use in the invention. The electrochemical sensor comprises a top cap 1 defining an aperture 2 within which is mounted a PTFE insert 3. The insert 3 has been milled to produce a channel 4 of 1 mm² cross section by 10 mm long, with one side of the channel being in direct contact with a PTFE sensing electrode/membrane 5. 1 mm diameter holes 6,7 are drilled at each end of the channel 4 for gas access. The sensing electrode 5 is sealed to the cap 1 by means of an O-ring 9.

A casing 10 is mounted below the cap 1 in which are provided a counter electrode 10A and (optional) reference electrode 10B. This is the same configuration as a conventional electrochemical sensor and need not be further described. In one example, a pulse of gas to be detected entrained in air flows through the channel 4. The gas sample will be at least partly consumed on the sensing electrode 5 as described below, while unreacted air passes out through the hole 7 into a PTFE tube 8 connected to a pump (not shown).

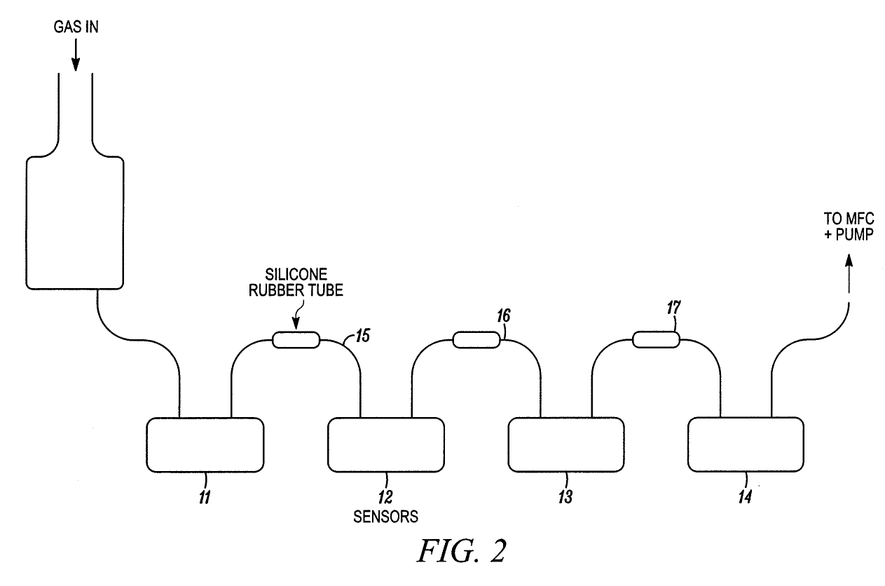

In some examples, a sequence of sensing electrodes and corresponding counter electrodes and electrolyte may be provided as shown in FIG. 2, the flow channels 4 of the sensor assemblies 11-14 being coupled together by tubes 15-17, such as PTFE or silicone rubber tubes, or a material chosen to be compatible with the flowing gas(es).

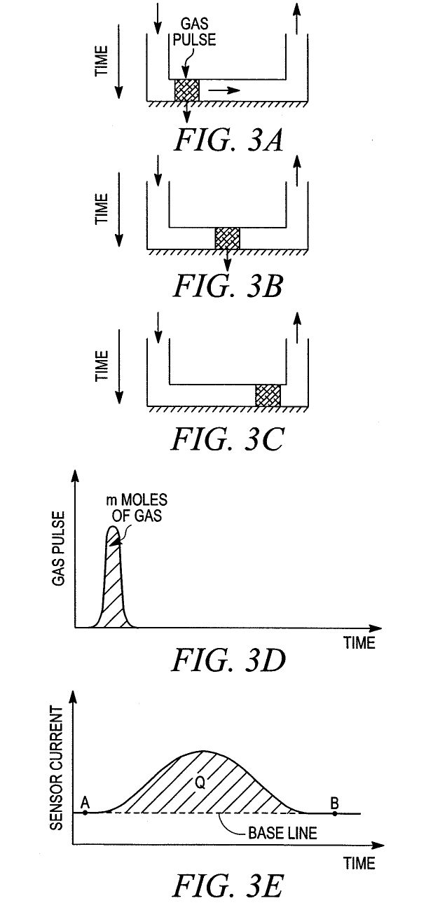

The basic principle behind operation of the flow design is that the target gas (e.g. CO) should be substantially, sometimes completely, consumed by the sensor or sensors as it flows along the channel. The behaviour where a gas pulse is completely consumed is most easily modelled by considering a pulse of gas, as shown schematically in FIGS. 3A-3C. If the pulse of gas is completely consumed then for each molecule of carbon monoxide, 2 electrons are produced:

Sensing electrode: CO+H₂O→CO₂+2H⁺+2e⁻

Counter electrode: ½O₂+2H⁺+2e⁻→H₂O 1

The total charge, Q, produced by reaction of the gas pulse is therefore:

Q=nFm 2

Where n is the number of electrons transferred per gas molecule (n=2 in the case of CO), F is the faraday constant (96485 C mol⁻¹) and m is the number of moles of gas in the gas pulse.

Therefore the total integrated current from the sensor should directly allow calculation of the amount of gas in the sample, irrespective of sensor catalyst activity, flow channel dimensions, flow rate, temperature etc.—provided that all of the gas is consumed by the sensor. This is in contrast to conventional electrochemical gas sensor operation where the sensor needs to be calibrated to account for the effects of catalyst and/or capillary, and needs to be temperature compensated for maximum accuracy.

The speed of response of the sensor should also not influence the results, as indicated in FIGS. 3D and 3E. FIG. 3D represents the gas concentration as a function of time, demonstrating that regardless of the shape, width etc of the actual gas pulse, the integrated charge, Q, in FIG. 3E is a direct measure of the number of moles (M) of gas in the pulse, even if the time response of the sensor is slow compared with the width of the pulse. The sensor signal may be delayed due to diffusion through the electrode membrane and reaction with the catalyst etc, but the total charge passed should still be correct.

The behaviour for a continuous flow of gas through the channel can be derived as follows:

Volume of flow cell=v/cm³

Flow rate through flow cell=f/cm³s⁻¹

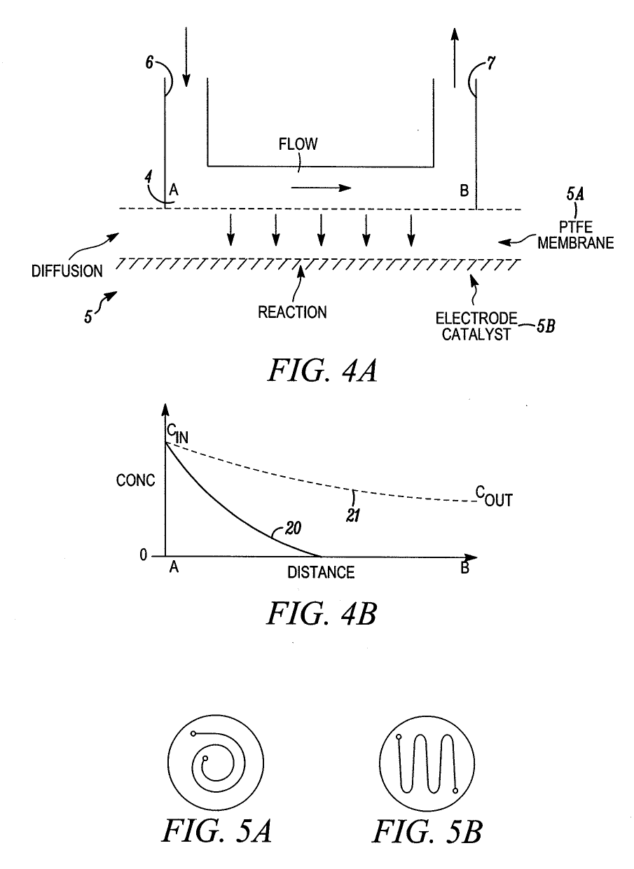

FIG. 4A illustrates a flow cell and FIG. 4B illustrates graphically the variation in concentration of a gas sample along the flow channel 4 under steady state conditions for situations in which all gas is consumed within the channel (curve 20) and where some gas escapes unreacted (curve 21). As can be seen in FIG. 4, the gas diffuses through a PTFE membrane 5A to electrode catalyst 5B.

For simplicity, the reaction of gas is assumed to be first order and is treated as a homogeneous reaction within the channel, i.e. the apparent rate constant also incorporates the effects of diffusion of gas within the channel and through the membrane as well as the reaction at the three-phase boundary, as shown in 4. The reaction is therefore:

$$\frac{d c}{d t} = - kc \qquad 3$$

First order rate constant=k/s⁻¹
Gas concentration=c/moles cm⁻³ which decreases along the channel, from an initial value of c₀.

This gives the time dependence of the concentration at any one point as it flows along the channel as:

c=c₀e^{-kt} 4

The total available reaction time, t, is the residence time of gas within the channel:

$$t = \frac{v}{f} \qquad 5$$

where f is the flow rate (cm³s⁻¹)

The flow rate can be determined using, for example, a thermal flow meter such as a mass flow meter, or could be controlled using a pump with constant or controlled flow rate.

The charge passed due to reaction of m moles of gas is:

Q=nFm 6

The total number of moles of gas reacted is given by:

m=(c₀−c_{end})v 7

Where c_{end} is the gas concentration at the outlet of the channel.

As described earlier, ideally all of the gas should be consumed within the channel—therefore c_{end} is zero, as shown in FIG. 4, line 20. Combination of equations 5, 6 and 7 gives the following equation for the current:

I=nFc₀f 8

There should therefore be a linear dependence of current on gas flow rate, f. The behaviour where the gas is not all consumed within the channel (c_{end}>0) is considered further below. Equation 8 can therefore be used to determine gas concentration if the flow rate is known, without requiring calibration of the sensor.

Equation 8 also shows that, if the flow rate and gas concentration are known, then the number of electrons, n, in the electrode reaction can be determined. This is useful in determining the mechanism of the gas response.

The simple theory described above breaks down if the gas is not entirely consumed within the flow channel by the single sensing electrode. In this case, a sequence of sensing electrodes can be used as shown in FIG. 2.

The general equation for the current in each sensor is:

I=nFf(cᵢₙ−cₒᵤₜ) 9

Where cᵢₙ is the concentration entering the sensor, and cₒᵤₜ is the concentration exiting the sensor. cₒᵤₜ can be calculated from cᵢₙ by substitution of equation 4:

I=nFfcᵢₙ(1−e^{-(kv/f)}) 10

For a single sensor, cᵢₙ can simply be replaced by c₀, whereas cᵢₙ for each subsequent sensor is determined by the gas consumption in the previous sensor. The currents observed in each of a sequence of sensors are therefore now a function of not only the flow rate, f, but also the rate constant, k, and channel volume, v, for the sensor and all preceding sensors.

If the channel volume in each sensor is known, then the rate constants, k, can be determined by curve fitting equation 10 to the flow dependence curves.

The theoretical model described above can be used to derive a correction factor for a system with more than one sensor (or sensing electrode) in series, but which does not consume all of the target gas.
From equation 10:

I₁=nFfcᵢₙ(1−e^{-(k}^{₁}^{v}^{₁}^{/f)}) 11

Where I₁, k₁ and v₁ are the relevant parameters for the first sensor in the flow series. From equation 4, the incoming concentration (c₂) to the next sensor in the flow series is:

c₂=cᵢₙe^{-(k}^{₁}^{v}^{₁}^{/f)} 12

Therefore the current, I₂, in the second sensor is given by:

I₂=nFfcᵢₙ(1−e^{-(k}^{₂}^{v}^{₂}^{/f)})e^{-(k}^{₁}^{v}^{ᵥ}^{₁}^{/f)} 13

Where k₂ and v₂ are the relevant parameters for the second sensor. Using the same approach, equations can also be written for each successive sensor in the flow series.

If the approximation is made that the kinetics and cell size are the same for the two sensors (i.e. k₁v₁=k₂v₂) then the ratio of the first two currents directly gives the fraction of gas consumed in the first sensor:

$$\frac{{I}_{2}}{{I}_{1}} = {e}^{- ( {k}_{1} {v}_{1} / f )} = \frac{{c}_{2}}{{c}_{i n}} \qquad 14$$

Similarly, the unreacted gas fraction, c₂ₒᵤₜ, escaping from the second sensor is given by:

$${( \frac{{I}_{2}}{{I}_{1}} )}^{2} = {e}^{- ( ( {k}_{1} {v}_{1} / f ) + ( {k}_{2} {v}_{2} / f ) )} = \frac{{c}_{2 out}}{{c}_{i n}} \qquad 15$$

The theoretical ideal current (I_{∞}), if all of the gas was consumed within the sensor(s), is:

I_{∞}=nFfcᵢₙ 16

This gives the following equation for the theoretical ideal current, based on the actual measured currents from the two sensors:

$${I}_{∞} = \frac{{I}_{1}}{1 - ( \frac{{I}_{2}}{{I}_{1}} )} \qquad 17$$

Note that this expression is independent of the values of the flow, volume and kinetics within the sensor(s)—with the proviso that the values of these parameters for the two sensors are approximately the same. Therefore the application of the correction factor (or calculation of unreacted gas fraction) does not require any knowledge of the system under test.

In the examples described so far, a simple rectilinear channel 4 with one sensing electrode per sensor assembly has been described. FIGS. 5A and 5B illustrate alternative forms of channel being a spiral or a serpentine form respectively. These produce a longer path length for a given sensing electrode area so as to maximize contact of gas with the sensing electrode.

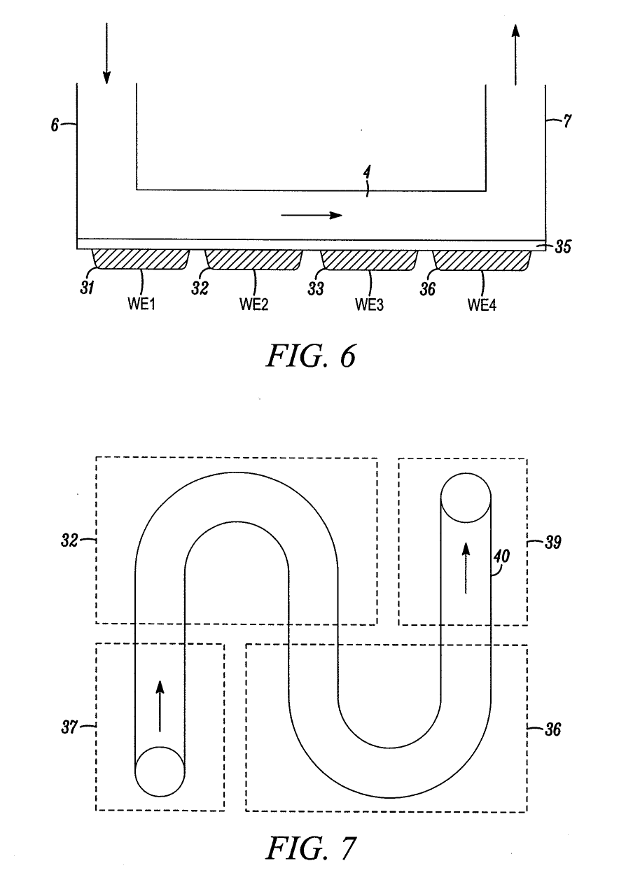

As shown in FIG. 6, techniques such as screen printing allow multiple sensing electrodes 31-34 to be deposited on a single PTFE membrane 35. In addition to the possibility of having sensing, reference and/or counter electrodes in a planar design, the ability to deposit multiple working electrodes allows the type of designs demonstrated here with multiple sensors to be implemented using a single sensor. FIG. 6 shows schematically 4 electrodes deposited along the length of a flow channel, and FIG. 7 illustrates an arrangement of electrodes 36-39 with a serpentine channel 40.

Embodiments of the invention have a number of applications. Embodiments which are combined with a pulsed sampling system (such as a thermal desorber or flow injection system) allow a direct measurement of the number of moles of gas in the sample, without requiring sensor calibration and independently of parameters such as flow rate, temperature etc (provided these are within reasonable limits). A certain amount of ‘self diagnostics’ is inherent in the approach if multiple sensor elements are used.

With a flowing sample, the gas concentration can also be measured without requiring sensor calibration, however the gas flow rate must be known. Again, the use of multiple sensor elements allows a certain amount of ‘self diagnostics’ and correction.

The system can also be used to obtain kinetic and other parameters from electrodes.

For example, the ‘activity’ of an electrode can be accurately measured in a controlled manner. The observed activity is a function of the true catalytic activity of the catalyst and the diffusion of gas through the supporting membrane. Conventionally, activity is measured by a very crude ‘open electrode’ test whereby bulk gas is applied at a high flow rate directly to a sensor with no capillary restriction. This results in a transient signal which reaches a maximum, then decays away as the electrode is overloaded (reaches its ‘tolerance’) and gas passes through causing an opposing signal on the counter/reference electrode. The peak signal gives a measure of the electrodes ‘activity’ but this will be partially dependent on the transient behaviour so extraction of a reliable rate constant is difficult.

Embodiments of the present invention allow a much more controlled approach to measurement of electrode activity. At low gas flow rates the sensor signal is independent of the electrode activity (equation 8). At a sufficiently high flow rate the current will deviate from this ideal faradaic value and will be given by equation 10, which allows the effective rate constant or ‘activity’ of the sensor to be determined. Furthermore, a second sensor downstream can also be used to validate or give an independent measure of the activity of the first sensor, using equation 13.

Furthermore, if the flow is increased sufficiently then the sensor will eventually reach its tolerance point with the result that the behaviour deviates from the theoretical value.

Embodiments of the present invention also allow the number of electrons, n, in the electrode reaction equation to be independently determined.

The use of lower gas flow rates also has logistical and financial benefits when testing large numbers of sensors.

All of the above data can then be used to predict the performance/stability/lifetime of sensors built with such electrodes and provided with a capillary diffusion barrier.

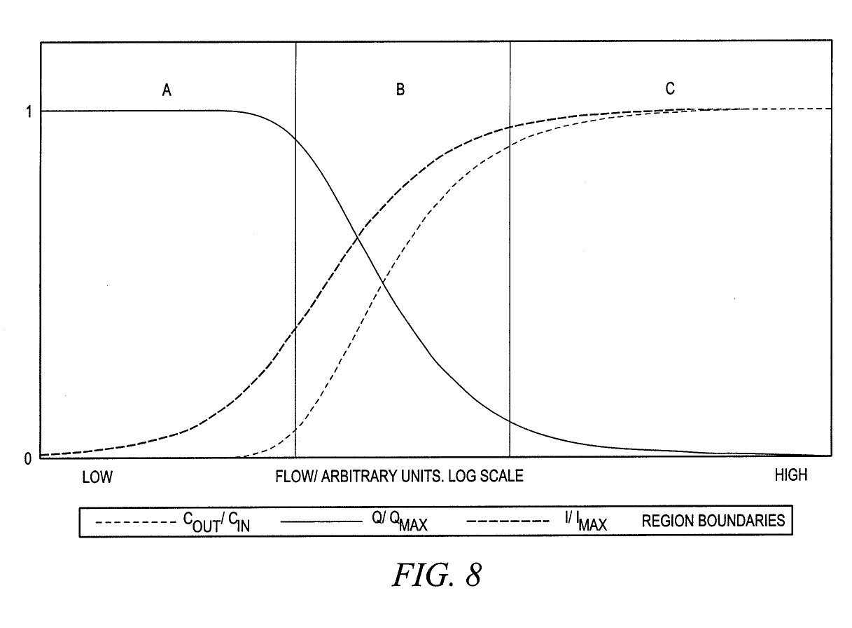

To assist in explaining the differences between methods according to the invention and prior art methods, FIG. 8 shows how the three parameters (gas consumption, charge and current) vary as a function of flow rate. Note that flow rate is shown in a logarithmic scale, i.e. it does not fall to zero at the left hand side. In practice, at very low flows the behaviour will deviate from the ideal behaviour shown here.

The three parameters on the chart are as follows:

The dotted curve shows concentration of gas at the flow channel exit relative to that at the inlet to the channel. At low flow rates, cₒᵤₜ/cᵢₙ is almost zero meaning that all gas is consumed within the channel. Conversely, at very high flow rates cₒᵤₜ/cᵢₙ approaches 1, i.e. almost all of the gas reaches the channel exit unreacted.

The dashed curve shows current for a given constant gas concentration normalised to the theoretical maximum current, which occurs at high flow rates.

The solid curve shows integrated charge relative to the theoretical maximum charge (equation 6) that would be observed for a pulse of gas, where the pulse contains a constant number of molecules of gas.

The chart is divided into three “flow regimes”, labelled A, B and C, for low, medium and high flows respectively.

Traditionally, sensors are operated in region C, where the current is limited by the diffusional limitation of the sensor membrane or capillary. When operated in an airflow, there is no significant depletion of gas concentration (cₒᵤₜ=cᵢₙ) and the current is independent of flow rate. If such a sensor was fed a small pulse of gas, since much of the gas would pass through the cell without being detected the charge would be relatively low (low faradaic efficiency). If the operating regime of a conventional sensor moves into region B, then the current is no longer determined by the diffusion limiting membrane or capillary, and the sensor reading becomes erroneously low.

The present invention, in its simplest form, uses a low flow (region A). Under these conditions, all of the gas is consumed within the channel by the sensor (cₒᵤₜ=0). The current is low and flow dependent, however the integrated charge is independent of flow and is at its maximum value (complete faradaic efficiency).

In the further embodiments of the present invention, e.g. where more than one sensor in series is used, the intention is to measure and/or correct for the effects of the flow regime moving into region B. Here, the charge starts to drop from its theoretical maximum value, but by using a second downstream sensor, or preferably a second sensing electrode within the same sensor, to effectively measure the concentration of gas leaving the first sensor, it is possible to correct for this deviation. Similarly, by utilising the relative currents on the two (or more) sensors, it is possible to extract information about the reactions occurring in the sensor(s). However, the accuracy of these measurements becomes worse as the flow increases further into region B. Thus, the present invention can be considered to occupy region A and the left hand side of region B.

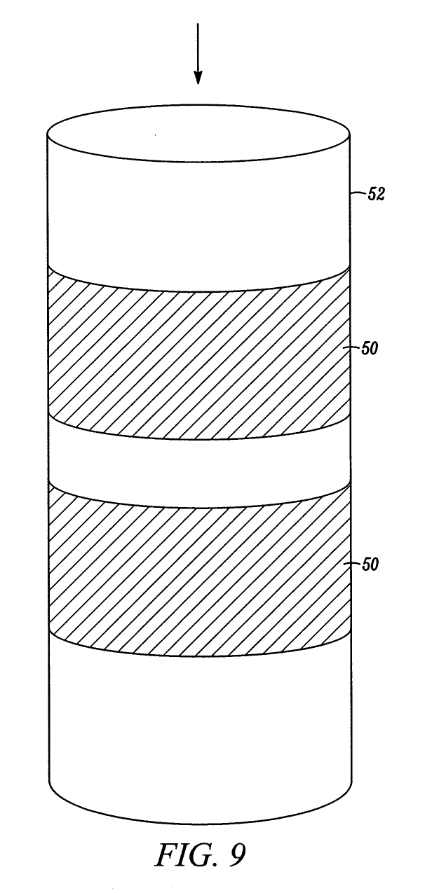

FIG. 9 shows another possible implementation of the invention, whereby the sensing electrode or electrodes 50 are provided on the outer surface of a hollow tube 52 of gas permeable material. Gas flows along the inside of the tube 52, which is immersed in the electrolyte. Counter and/or reference electrodes are not shown but could, for example, be arranged concentrically around the tube 52 or could be in a conventional planar form.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A method of determining information about a gas sample using an electrochemical gas sensor assembly having one or a number of sequentially arranged sensing electrodes, one or more counter electrodes, and an electrolyte, the sensor assembly including one or more flow channels extending across the or all the sensing electrodes, the method comprising:
causing bulk flow of the gas sample in an airstream along the flow channel(s) such that all or a significant fraction of the gas sample is consumed on the sensing electrode(s) whereby one or more electrolytic currents are generated, and
monitoring the electrolytic current(s) so as to determine information about the gas sample.

2. A method according to claim 1, wherein the electrolytic current is used to determine one of the concentration and amount of gas in the gas sample.

3. A method according to claim 2, wherein the method comprises determining the total charge Q produced by the reaction of the gas in accordance with a formula:
Q=nFm
where n is the number of electrons transferred per molecule of reacting gas, F is the Faraday constant, and m is the number of moles of gas.

4. A method according to claim 1 or claim 2, wherein a continuous flow of gas occurs through the channel, the concentration of gas entering the channel (c₀) being determined using the formula:
I=nFc₀f
where I is the electrolytic current that is measured, n is the number of electrons transferred per molecule of reacting gas, F is the Faraday constant, and f is the volume flow rate.

5. A method according to claim 1, wherein the sensor assembly comprises two sensors in series or two sensing electrodes within one sensor, and wherein the rate constant (k₁) of the first sensing electrode is determined using the formula:
$$\frac{{I}_{2}}{{I}_{1}} = {e}^{- ( {k}_{1} {v}_{1} / f )}$$
where I₁ and I₂ are the electrolytic currents from the first and second sensing electrodes respectively, f is the volume flow rate, and v₁ is the volume of the channel associated with the first sensing electrode.

6. A method according to claim 1, wherein the sensor assembly comprises two or more sensors in series, or two or more sensing electrodes within one sensor, the method comprising monitoring the electrolytic current on each sensing electrode or sensor to detect the presence of more than one gas in the gas sample.

7. A method according to claim 1, wherein the sensor assembly comprises two or more sensors in series, or two or more sensing electrodes within one sensor, the method comprising monitoring the electrolytic current on each sensing electrode or sensor to determine a selected current corresponding to full consumption of a gas sample.

8. A method according to claim 7, wherein the selected current (I_{∞}) is determined from the formula:
$${I}_{∞} = \frac{{I}_{1}}{1 - ( \frac{{I}_{2}}{{I}_{1}} )}$$
where I₁ and I₂ are the monitored currents from two sequential sensors or sensing electrodes.

9. A method according to claim 1, wherein a plurality of sensing electrodes are sequentially arranged, and at least 10%, preferably at least 50%, most preferably at least 75% of a given volume of the gas sample is consumed within the gas sensor assembly.

10. A method according to claim 1, wherein the gas sample is fully consumed on a single electrode.

11. A method according to claim 1, wherein a single sensing electrode is provided, and wherein at least 90% of a given volume of the gas sample is consumed within the gas sensor assembly.

12. A method according to claim 1, wherein the gas sample is provided in the form of a gas pulse.

13. A method according to claim 1, wherein the gas sample is supplied in the form of a continuous flow.

14. A method according to claim 1, wherein the gas sample comprises one of CO, H₂S, SO₂, NO, NO₂, Cl₂ and O₃.

15. A method according to claim 1, wherein the channel extends across more than one sensing electrode, with the sensing electrodes carried on a common support.

16. A method according to claim 15, wherein a common counter electrode is provided.

17. A method according to claim 15, wherein the or each flow channel has one of a rectilinear, curved, serpentine, and spiral form.

18. A method according to claim 1, wherein the channel is in the form of a tube, the or each sensing electrode being provided on a surface of the tube.

19. A method comprising:
providing at least one flow channel;
providing at least one sensing electrode adjacent to the flow channel;
providing a gas sample in the flow channel;
causing bulk flow of the gas sample in an airstream along the flow channel such that at least a significant fraction of the gas sample is consumed on the sensing electrode whereby at least one electrolytic current is generated, and
monitoring the electrolytic current so as to determine information about the gas sample.
